(19) United States
(12) Patent Application Publication
(10) Pub. No.: US 2025/0210961 A1
(43) Pub. Date: Jun. 26, 2025

(54) ELECTRICAL ASSEMBLY

(71) Applicant: Lear Corporation, Southfield, MI (US)

(72) Inventor: Roser Rue Olive, Tarragona (ES)

(21) Appl. No.: 18/394,817

(22) Filed: Dec. 22, 2023

(51) Int. Cl. H02H 3/04; H02H 1/00; H02H 3/06; H02H 3/20; H02J 7/00

(52) U.S. Cl. CPC H02H 3/042; H02H 1/003; H02H 3/066; H02H 3/207; H02J 7/00308; H02J 7/0036; H02J 7/00712

(57) ABSTRACT

An electrical assembly includes a voltage source, an electrical load, a converter, and an electrical subsystem. The electrical load may be selectively electrically connected to the converter. The voltage source may be electrically connected with the converter; and the electrical subsystem may be electrically connected to the electrical load, the converter, and the voltage source. Further, the electrical subsystem may comprise a first circuit section including a filter component and a second circuit section including a gain component. In accordance with detecting a fault, the electrical subsystem interrupts operation of the converter. Additionally, the converter may convert AC power to DC power to charge the electrical load via the voltage source.

### TECHNICAL FIELD

The present disclosure generally relates to electrical assemblies, including assemblies that may include electrical loads disconnecting and reconnecting and/or dynamic alarms that may, for example, be used in connection with detecting disconnection of said electrical loads.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1A is a block diagram generally illustrating an embodiment of an electrical assembly according to teachings of the present disclosure.

FIG. 1B is a block diagram generally illustrating an embodiment of an electrical assembly according to teachings of the present disclosure.

FIG. 2 is a circuit schematic view generally illustrating an embodiment of the converter of an electrical assembly according to teachings of the present disclosure.

FIG. 3 is a circuit schematic view generally illustrating an embodiment of a first circuit section and a second circuit section of an electrical assembly according to teachings of the present disclosure.

FIG. 4 is a circuit schematic view generally illustrating an embodiment of at least one alarm of an electrical assembly according to teachings of the present disclosure.

FIG. 5 is a graph generally illustrating an increase in the input voltage to the electrical load according to teachings of the present disclosure.

FIG. 6 is a graph generally illustrating voltages and responses from the one or more alarms of the electrical assembly according to teachings of the present disclosure.

FIG. 7 is a flowchart generally illustrating a method of operating the electrical assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

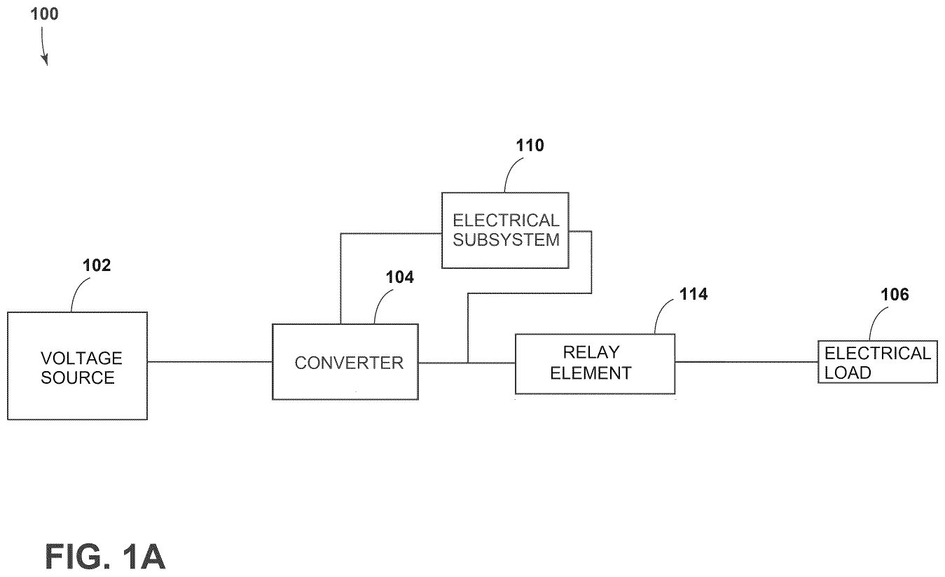

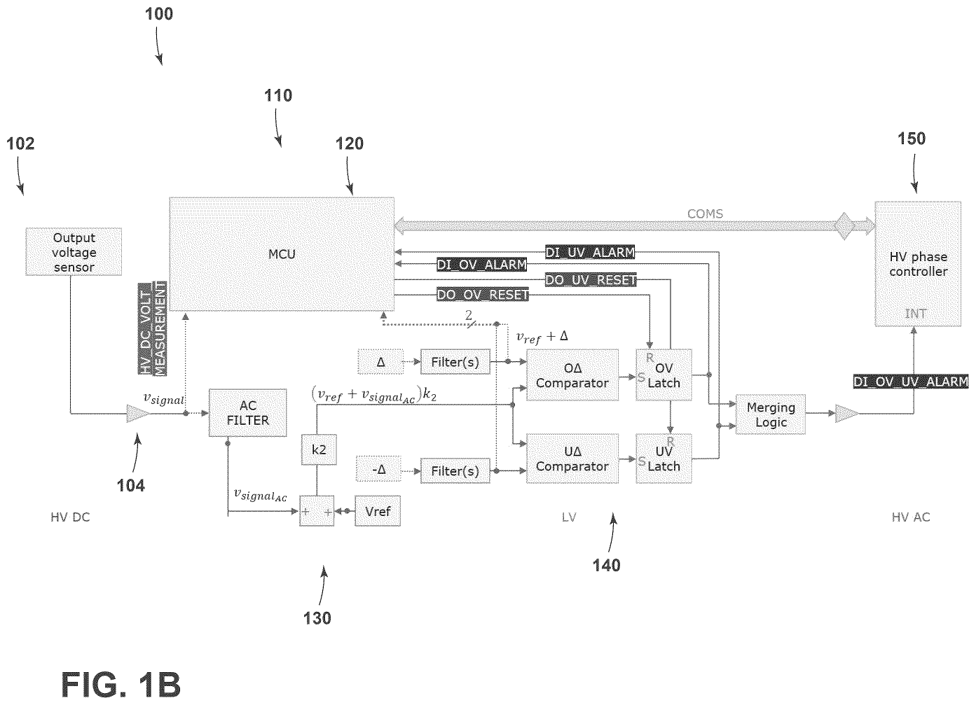

In embodiments, such as generally illustrated in FIG. 1A, an electrical assembly 100 may include a voltage source 102 (e.g., an AC grid) connected or coupled (e.g., electrically coupled) with a converter 104 and/or an electrical load 106, and further, the electrical assembly 100 may include an LLC topology. The converter 104 may be selectively electrically connected to the voltage source 102 such as to be selectively operable in accordance with detection of a fault. The converter 104 may be responsible for converting AC power to DC power in providing power to the electrical load 106 via the voltage source 102. For example and without limitation, the electrical load 106 may be a battery of an electric vehicle 100A; and further, the electrical assembly 100 may detect a fault during selective connection (e.g., disconnection and reconnection) of the electrical load 106. The voltage source 102 may be selectively coupled with the electrical load 106 to selectively charge the electrical load 106. In embodiments, the electrical assembly 100 may experience one or more of a variety of faults as the electrical load 106 is disconnected and reconnected from the converter 104. One or more of a variety of faults may be associated with the electrical assembly transitioning between operation in a first state (e.g., associated with an inductive region) and a second state (e.g., associated with a capacitive region). Further, the converter 104 may be operating in the first state and/or the second state in response to disconnection of the electrical load 106 from the converter 104 (e.g., in response to a change in load). Power may be converted in an inductive zone, and when the electrical load 106 reconnects with the converter 104 (e.g., changing the load from light to heavy) the same frequency can move the converter 104 from the inductive zone to the capacitive zone where, for example, one or more MOSFETS of the electrical assembly 100 may experience a shoot through current.

With embodiments, the electrical assembly 100 may include an electrical subsystem 110 to monitor and/or control operation of the electrical assembly 100 and connected components. Monitoring and controlling the electrical assembly 100 via the electrical subsystem 110 may limit damage to the converter 104 in situations where the electrical load 106 is disconnected and/or reconnected. The electrical subsystem 110 may be electrically coupled with the voltage source 102, the converter 104, and/or the electrical load 106. In further examples, the voltage source 102 can be a high AC voltage source suitable for charging a vehicle battery; however, the voltage source may not be limited to such embodiments. The voltage source 102 may be a variety of power supplies (e.g., of any variety of voltage) with selectively connected loads, and with such, the electrical subsystem 110 can monitor and/or protect one or more of a variety of electrical loads connected therewith (e.g., to limit damage to electrical loads 106 reconnected with converters 104).

For example and without limitation, as shown in FIG. 1A, the voltage source 102 may be selectively electrically connected with a vehicle which may include a converter 104, an electrical load 106, and/or an electrical subsystem 110. The electrical subsystem 110 may be configured to limit damage (e.g., a short circuit condition) to the vehicle when disconnecting and reconnecting the electrical load 106 (e.g., in a charging manner). For example and without limitation, the electrical assembly 100 may include a relay element 114 coupled between the converter 104 and the electrical load 106.

With examples, such as generally illustrated in FIG. 1B (i.e., a more detailed illustration of an embodiment such as that in FIG. 1A), the electrical assembly 100 may include a converter output voltage sense circuit into the electrical subsystem 110, which also may include a controller 120. The controller 120 may be configured to receive one or more electrical signals from one or more portions of the electrical subsystem 110. For example and without limitation, the controller 120 may receive one or more electrical signals from the converter 104, a first circuit section 130 (e.g., comprising a filter element and a gain element), and/or a second circuit section 140 (e.g., comprising an alarm circuit). In other embodiments, the controller 120 may be coupled with one or more phase controllers 150, for example, to detect an overvoltage or undervoltage condition.

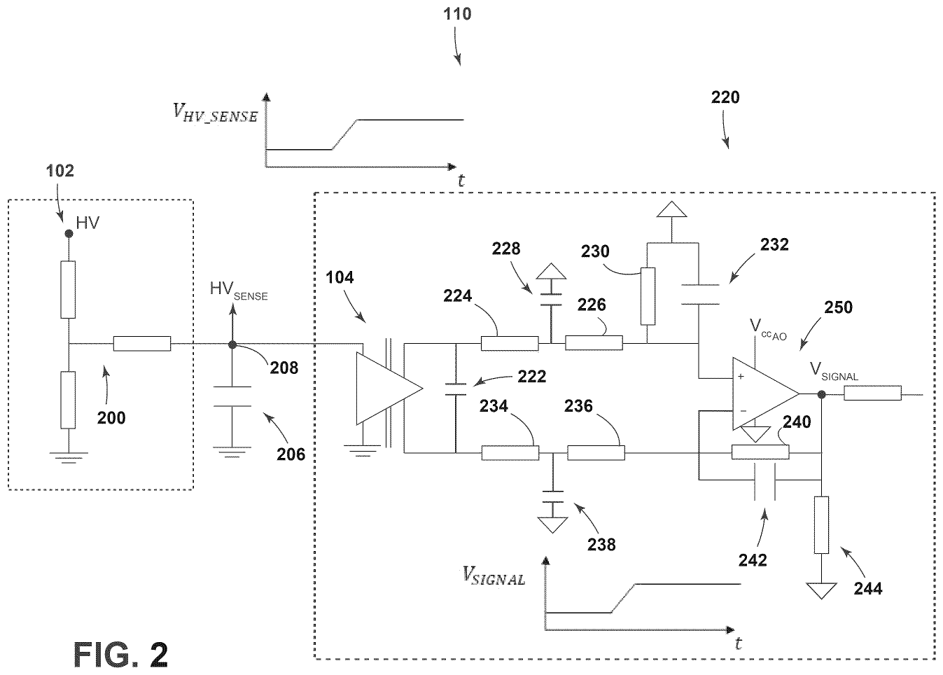

In examples, such as generally illustrated in FIG. 2, a voltage divider circuit 200 may be coupled to the electrical load 106 if the relay 114 is closed. The first node 208 may include a high voltage signal (HV_{SENSE}) indicating the voltage of the converter 104. The converter 104 may receive the DC signal from the electrical load 106 and may sense a HV_{SENSE} signal in LV (low voltage) domain (V_{SIGNAL}), via a sense circuit 220, to analyze performance and operation of the electrical system 100. The sense circuit 220 may include a first capacitor 222 coupled in parallel with the converter 104. Additionally, a first resistor 224 may be connected in parallel with the first capacitor 222. The first resistor 224 may be coupled in parallel with a second resistor 226 and/or a second capacitor 228 (e.g., further coupled to ground). Further, the second resistor 226 may be coupled in parallel with a third resistor 230, a third capacitor 232, and/or a positive terminal of an operational amplifier 250. A ground may be coupled between the third resistor 230 and the third capacitor 232 (e.g., commonly referred to as a differential to a single-ended output voltage circuit).

With further embodiments, the first capacitor 222 may be electrically coupled in parallel with the converter 104 and/or a fourth resistor 234. The fourth resistor 234 may be coupled in parallel with a fifth resistor 236 and/or a fourth capacitor 238 (e.g., further coupled to ground). The fifth resistor 236 may be coupled with a sixth resistor 240, which may be coupled in parallel with a fifth capacitor 242 and/or a negative terminal of the operational amplifier 250. The sixth resistor 240 and the fifth capacitor 242 may be coupled in parallel with a seventh resistor 244 coupled with the output of the operational amplifier 250. The sense circuit 220 may be configured to extract V_{SIGNAL} from V_{HV_SENSE} such as shown in FIG. 2.

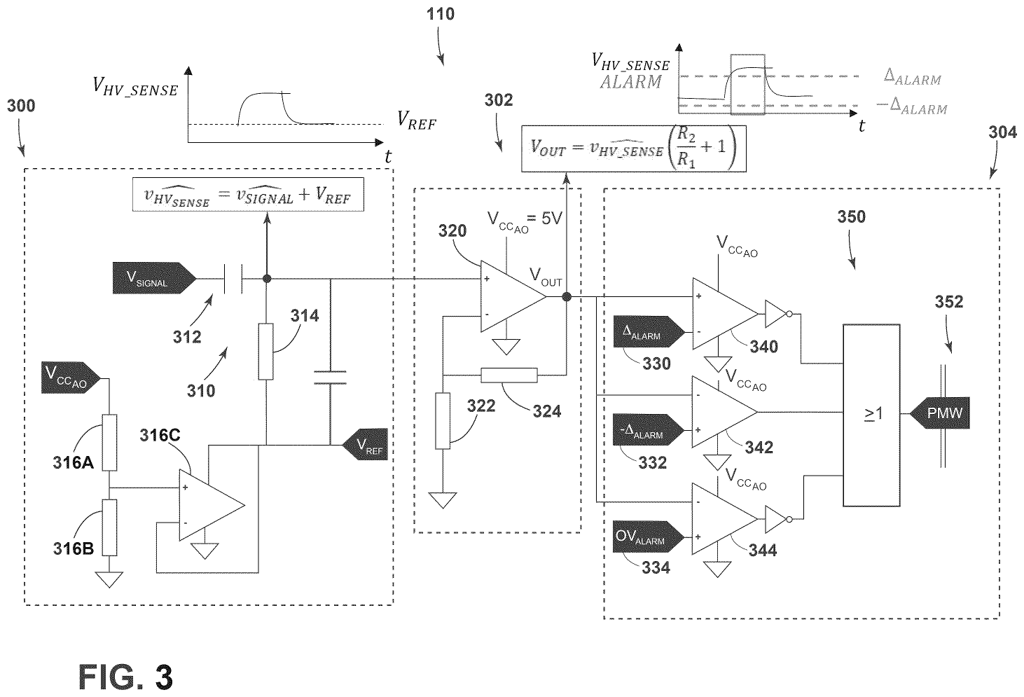

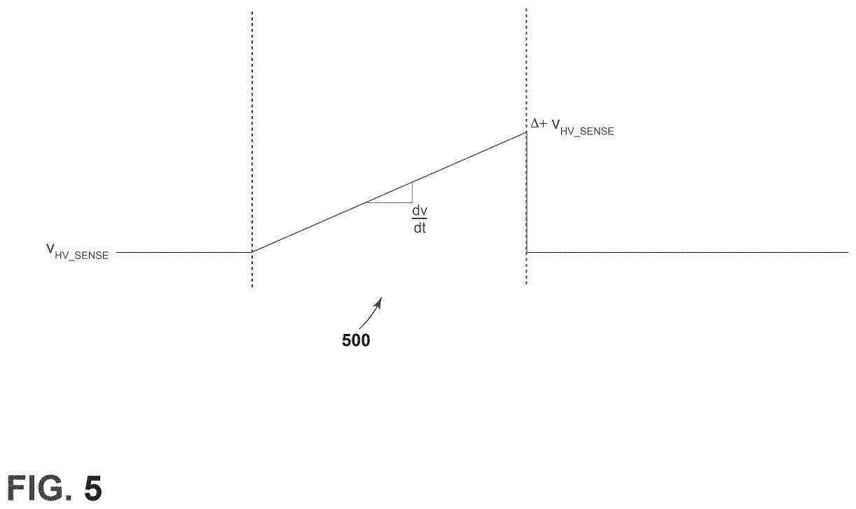

With embodiments, such as generally illustrated in FIG. 3, the electrical subsystem 110 may include a first circuit section 300, a second circuit section 302, and/or an alarm circuit 304. The first circuit section 300 may receive the voltage signal (V_{SIGNAL}) and a filter component 310 may be configured to sense the AC portion (VHV [symbol] ) of the voltage signal (V_{SIGNAL}). The filter component 310 may include a capacitor 312 coupled in parallel with a resistor 314. The resistor 314 may be coupled in parallel with a second capacitor 314B and an operational amplifier 316C, which the combination of such can filters the voltage signal (V_{SIGNAL}) to generate the AC voltage signal (VHV [symbol] ), as shown in FIG. 5. The resistor 314 may be coupled with a reference voltage signal (V_{REF}) to add an offset at AC signal to detect a positive or negative overvoltage. For example and without limitation, the reference voltage signal (V_{REF}) may be about 0.25 V, or 1 V, or more or less. The reference voltage signal (V_{REF}) may be provided to the resistor 314 via an operational amplifier circuit 316 electrically connected with the resistor 314. The reference voltage signal (V_{REF}) may be any variety of voltages that correspond to any variety of desired offset level. The first circuit section 300 may be coupled with the second circuit section 302 such that both positive and negative variations in voltage can be detected/sensed.

In examples, the operational amplifier circuit 316 may include a supply voltage (V_{CCAO}) electrically connected to a first resistor 316A and a second resistor 316B coupled in series. The operational amplifier circuit 316 may include an operational amplifier 316C coupled between the first resistor 316A and the second resistor 316B. Further, the positive terminal of the operational amplifier 316C may be coupled between the resistors 316A, 316B. The negative terminal of the operational amplifier 316C may be electrically coupled to resistor 314.

In embodiments, the second circuit section 302 may apply a gain to the signal received from the first circuit section 300. The second circuit section 302 may apply a gain to increase the sensitivity of detecting faults (e.g., detecting disconnection of the electrical load 106). To apply a gain to the received signal, the second circuit section 302 may include an operational amplifier 320, a first resistor 322, and a second resistor 324 (e.g., a gain component). The voltage signal (VHV [symbol] ) may be received by a positive terminal of the operational amplifier 320. Further, the negative terminal of the operational amplifier 320 may be coupled between the first resistor 322 and the second resistor 324. The first resistor 322 may be coupled to a ground, and the second resistor 324 may be coupled with the output of the operational amplifier 320. The output of the second circuit section 302 may be expressed as:

$${V}_{HV} ( \frac{R 1}{R 2} + 1 ) .$$

Further, R1 may correspond to the first resistor 322 and R2 may correspond to the second resistor 324. The output of the second circuit section 302, as shown in FIG. 5, may be received by one or more alarms of the alarm circuit 304 associated with fault detection (e.g., in sensing the disconnection of the electrical load 106 from the voltage source 102) to deactivate the converter 104. The one or more alarms may include a first alarm 330, a second alarm 332, and/or a third alarm 334. The first alarm 330 may be configured to detect a fault associated with a dynamic increase (Δ) in the high voltage signal (HV_{SENSE}), and may be electrically coupled to a negative terminal of a first operational amplifier 340. The second alarm 332 may be configured to detect fault associated with a dynamic decrease (−Δ) in the high voltage signal (HV_{SENSE}), and may be electrically coupled to a positive terminal of a second operational amplifier 342. Additionally, the third alarm 334 may be configured to detect absolute value overvoltage and/or undervoltage condition for the high voltage signal (HV_{SENSE}) and may be electrically coupled to a positive terminal of a third operational amplifier 344.

With embodiments, the first operational amplifier 340, the second operational amplifier 342, and/or the third operational amplifier 344 may be electrically coupled with a logic circuit section 350 operable or configured to transmit a deactivation signal 352 to the controller 120 and/or the converter 104. The deactivation signal 352 may stop/limit operation of the converter 104 such as to prevent the electrical assembly 100 from operating in the second state (e.g., the capacitive region) when the electrical load 106 is reconnected to the converter 104. Further, the deactivation signal 352 may signify that the electrical load 106 has been disconnected from the converter 104. Reconnecting the electrical load 106 with the converter 104 operating can force the converter 104 to work in the second state (e.g., capacitive region) and may cause damage to one or more components of the converter 104 (e.g., such as bridge MOSFETS). Therefore, causing the converter 104 to operate in the first state (e.g., the inductive region) may prevent damage to the converter 104 when reconnecting the electrical load 106.

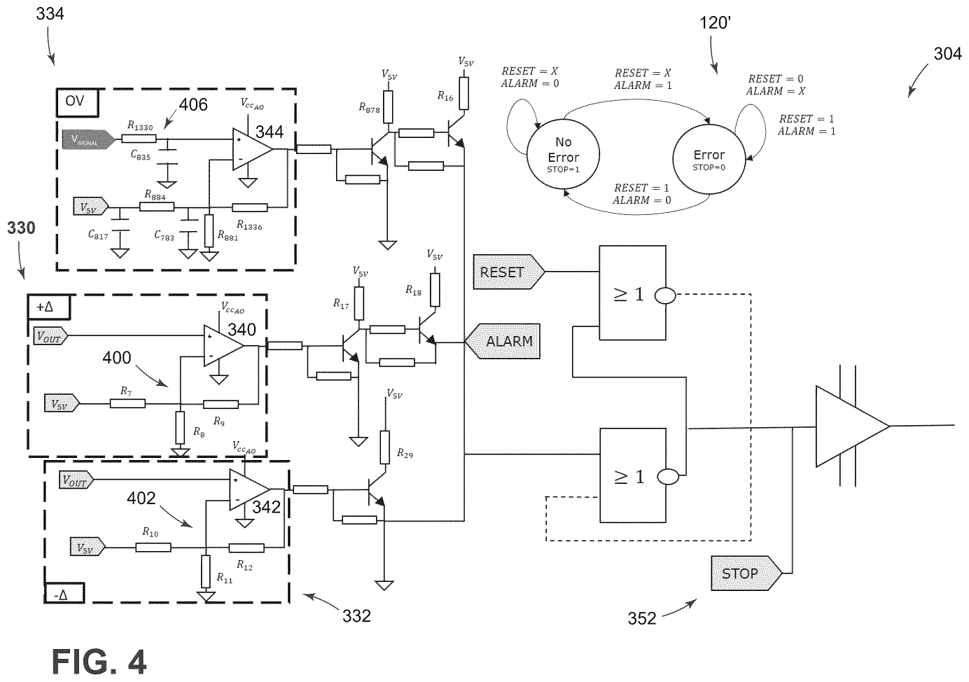

In examples such as generally illustrated in FIG. 4, the alarm circuit 304 may be coupled with the logic circuit section 350. The first alarm 330 includes a voltage divider circuit 400 coupled to the negative terminal of the first operational amplifier 340. Additionally, a resistor of the voltage divider circuit 400 may be coupled with a supply voltage of about 5V. The second alarm 332 includes a second voltage divider circuit 402 coupled to the negative terminal of the second operational amplifier 342. A resistor of the second voltage divider circuit 402 may be coupled with a supply voltage of about 5V.

With embodiments, the third alarm 334 may include a first filter circuit 406 (comprising a resistor and capacitor couple in parallel to the positive terminal of the third operational amplifier 344). The negative terminal of the third operational amplifier 344 may be coupled with three resistors and a capacitor in parallel, where one resistor may be coupled with a second capacitor and voltage source (e.g., 5V). Further, the capacitor may be coupled between two of the three resistors coupled in parallel. The logic circuit section 350 is shown in further detail where the alarm status may be communicated and determined by the controller 120 and associated controller logic 120′.

Turning next to FIG. 5, the high voltage signal (HV_{SENSE}) is shown as having an increase (Δ) in voltage in plot 500. The voltage of the high voltage bus (e.g., the voltage source 102) is increasing and can be sensed via the electrical subsystem 110. The electrical subsystem 110 may extract and scale voltage measurements to increase the sensitivity of fault detection (e.g., lesser changes in voltages can be sensed and the converter 104 may be deactivated in response), and alarm circuit 304 may be configured to detect the increase (Δ) in voltage in comparison to any number of thresholds.

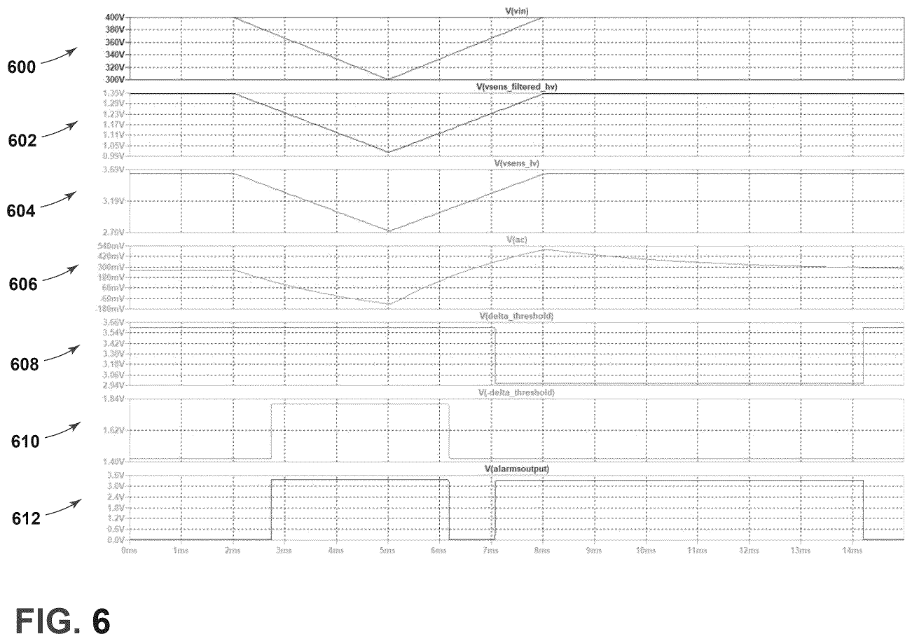

With embodiments, such as generally illustrated in FIG. 6, the high voltage signal (HV_{SENSE}) may be greater than a variety of thresholds (e.g., as determined by the resistance values selected for the resistors in electrical subassembly 110, and in response, the deactivation signal 352 may be transmitted to deactivate the converter 104.

In examples, the electrical subsystem 110 may be configured to transmit the deactivation signal 352 to the converter 104 in response to activation of the first alarm 330, the second alarm 332, and/or the third alarm 334.

For example and without limitation, as generally illustrated in FIG. 6, one or more signals may be received by the electrical subsystem 110 (e.g., the controller 120) for analysis and/or fault determination/comparison. For example and without limitation, the one or more signals may include a first signal 600 (e.g., HV) that may represent the voltage of the voltage source 102 (e.g., the high voltage bus). A second signal 602 (HV_{SENSE}) may be generated from filtering the first signal 600. A third signal 604 may be generated by the sensing circuit 220 (e.g., V_{SIGNAL}). Further, a fourth signal 606 may be generated after applying a gain (e.g., VOUT).

As can be seen from FIG. 6, as the voltage of the fourth signal 606 reaches a maximum positive A threshold voltage, the voltage change may be detected and, in response, a logic status of a fifth signal 608 may change. As the voltage of the fourth signal 606 reaches a maximum negative A threshold voltage, the voltage change may be detected and, in response, a logic status of a sixth signal 610 may change. Additionally, in response to the voltage of the fourth signal 606 being greater than an overvoltage threshold or less than an undervoltage threshold, a seventh signal 612 may be generated and the logic status of such may change when the voltage is outside a preferred threshold voltage. The first alarm 330 may be represented by fifth signal 608 (e.g., indicating a positive ΔV); the second alarm 332 may be represented by sixth signal 610 (e.g., indicating a negative ΔV); and/or the sum of the alarms may be represented by seventh signal 612 (e.g., indicating an OV/UV, positive ΔV, and/or negative ΔV). Hysteresis based alarm settings and/or analysis may be applicable to the fifth signal 608 and/or the sixth signal 610.

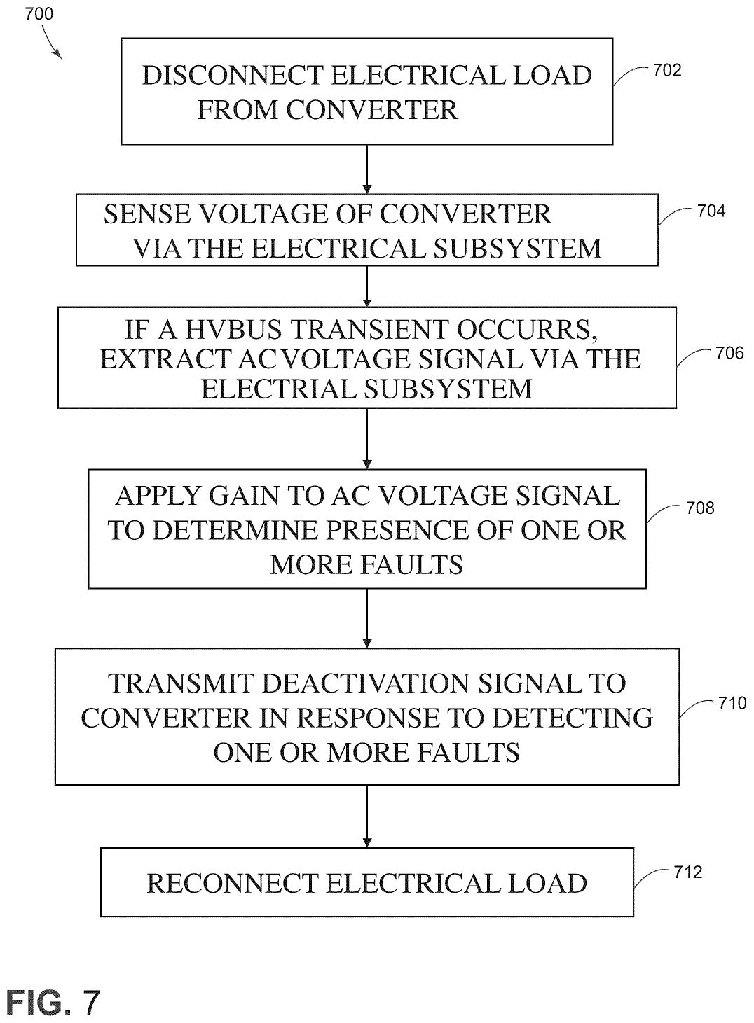

With embodiments, such as generally illustrated in FIG. 7, a method 700 of operating the electrical assembly 100 may include disconnecting the electrical load 106 from the converter 104 (step 702). In examples, disconnecting the electrical load 106 may correspond to disconnecting a vehicle (e.g., a battery) from a charging station. In response to disconnection of the electrical load 106, the method 700 may comprise sensing a voltage of the converter 104 via the electrical subsystem 110 (step 704). The electrical subsystem 110 may be configured to detect one or more faults associated with the electrical assembly 100 switching between operating in the first state and the second state. To detect one or more faults, the method 700 may comprise the electrical subsystem 110 extracting the AC voltage signal (VHV [symbol] ) from the HV bus signal (V_{SIGNAL}) via the first circuit section 300 (step 706). Further, the method 700 may comprise applying a gain to the AC voltage signal (VHV [symbol] ) to determine the presence of one or more faults (e.g., with a high degree of sensitivity, of about 0.1V to about 1V, or more or less) (step 708).

In embodiments, the method 700 may include detecting one or more faults associated with a decrease in voltage, an increase in voltage, or an undervoltage/overvoltage condition (step 710). In response to detecting the one or more faults, the method 700 may comprise transmitting the deactivation signal 352 to the converter 104 to interrupt operation. Interrupting the converter 104 may allow the electrical assembly to operate in the inductive region (e.g., first state), rather than the capacitive region (e.g., second state) when reconnecting the electrical load 106.

The disclosure includes, without limitation, the following embodiments:
1. A system comprising: a voltage source electrically connected with a converter; an electrical load selectively electrically connected to the converter; and an electrical subsystem electrically connected to the electrical load, the converter, and the voltage source, the electrical subsystem comprising: a first circuit section including a filter component; and a second circuit section including a gain component; wherein, in accordance with detecting a fault the electrical subsystem interrupts operation of the converter.
2. The system of embodiment 1, wherein the converter converts AC power to DC power to charge the electrical load via the voltage source.
3. The system according to any of the preceding embodiments, wherein the electrical subsystem is configured to sense if the system is operating in a first state associated with an inductive region or a second state associated with a capacitive region.
4. The system according to any of the preceding embodiments, wherein the fault indicates disconnection of the electrical load from the converter.
5. The system according to any of the preceding embodiments, wherein the first circuit section receives an input voltage and removes an AC portion of the input voltage.
6. The system according to any of the preceding embodiments, wherein the first circuit section comprises a capacitor and a resistor coupled in parallel.
7. The system according to any of the preceding embodiments, wherein the first circuit section adds a reference voltage to the input voltage received by the first circuit section.
8. The system according to any of the preceding embodiments, wherein the reference voltage is coupled to the resistor of the first circuit section.
9. The system according to any of the preceding embodiments, wherein the second circuit section applies a gain to the input voltage after the input voltage is filtered via the first circuit section.
10. The system according to any of the preceding embodiments, wherein at least one alarm is coupled with an output of the second circuit section, the alarm detecting the fault and, in accordance with detecting the fault, the electrical subsystem stops operation of the converter.
11. The system according to any of the preceding embodiments, wherein the at least one alarm is configured to sense the fault, and the fault is associated with an increase in voltage above a threshold voltage.
12. The system according to any of the preceding embodiments, wherein the at least one alarm is configured to sense the fault, and the fault is associated with a decrease in voltage below a threshold voltage.
13. The system according to any of the preceding embodiments, wherein the at least one alarm is configured to sense the fault, and the fault is associated with an overvoltage or an undervoltage condition.
14. A method of operating the system of embodiment 1 comprising: providing voltage from the converter to the electrical load; monitoring the voltage from the converter via the electrical subsystem; disconnecting the electrical load from the converter; and in accordance with detecting the fault: providing a signal from the electrical subsystem to the converter to interrupt operation of the converter.
15. The method according to any of the preceding embodiments, wherein detecting the fault comprises the electrical subsystem determining when the converter transitions from operating in an inductive region to a capacitive region after disconnection of the electrical load from the voltage source.
16. The method according to any of the preceding embodiments further comprising: reconnecting the electrical load with the converter via the electrical subsystem.
17. A system, comprising: a power source providing a voltage of at least 400 V; a converter coupled between the power source and an electrical load selectively electrically connected with the converter; and an electrical subsystem electrically connected to the power source, the converter, and the electrical load; wherein, in accordance with detecting a fault associated with operation of the system in a capacitive region after disconnecting the electrical load, the electrical subsystem interrupts operation of the converter before reconnecting the electrical load.
18. The system according to any of the preceding embodiments, wherein the electrical subsystem is configured to filter a voltage signal from the converter and apply a gain before detecting the fault.
19. The system according to any of the preceding embodiments, wherein the electrical subsystem applies a reference voltage to the voltage signal before detecting the fault.
20. The system according to any of the preceding embodiments, wherein the fault indicates at least one of an increase in voltage greater than a first threshold value, a decrease in voltage greater than a second threshold value, and an undervoltage or overvoltage condition.

In examples, a controller 120 or system may include an electronic controller and/or include an electronic processor, such as a programmable microprocessor and/or microcontroller. In embodiments, a controller may include, for example, an application specific integrated circuit (ASIC). A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

1. A system, comprising:
a voltage source electrically connected with a converter;
an electrical load selectively electrically connected to the converter; and
an electrical subsystem electrically connected to the electrical load, the converter, and the voltage source, the electrical subsystem comprising:
a first circuit section including a filter component; and
a second circuit section including a gain component;
wherein, in accordance with detecting a fault the electrical subsystem interrupts operation of the converter.

2. The system of claim 1, wherein the converter converts AC power to DC power to charge the electrical load via the voltage source.

3. The system of claim 1, wherein the electrical subsystem is configured to sense if the system is operating in a first state associated with an inductive region or a second state associated with a capacitive region.

4. The system of claim 1, wherein the fault indicates disconnection of the electrical load from the converter.

5. The system of claim 1, wherein the first circuit section receives an input voltage and removes an AC portion of the input voltage.

6. The system of claim 5, wherein the first circuit section comprises a capacitor and a resistor coupled in parallel.

7. The system of claim 6, wherein the first circuit section adds a reference voltage to the input voltage received by the first circuit section.

8. The system of claim 7, wherein the reference voltage is coupled to the resistor of the first circuit section.

9. The system of claim 6, wherein the second circuit section applies a gain to the input voltage after the input voltage is filtered via the first circuit section.

10. The system of claim 1, wherein at least one alarm is coupled with an output of the second circuit section, the alarm detecting the fault and, in accordance with detecting the fault, the electrical subsystem stops operation of the converter.

11. The system of claim 10, wherein the at least one alarm is configured to sense the fault, and the fault is associated with an increase in voltage above a threshold voltage.

12. The system of claim 10, wherein the at least one alarm is configured to sense the fault, and the fault is associated with a decrease in voltage below a threshold voltage.

13. The system of claim 10, wherein the at least one alarm is configured to sense the fault, and the fault is associated with an overvoltage or an undervoltage condition.

14. A method of operating the system of claim 1, the method comprising:
providing voltage from the converter to the electrical load;
monitoring the voltage from the converter via the electrical subsystem;
disconnecting the electrical load from the converter; and
in accordance with detecting the fault:
providing a signal from the electrical subsystem to the converter to interrupt operation of the converter.

15. The method of claim 14, wherein detecting the fault comprises the electrical subsystem determining when the converter transitions from operating in an inductive region to a capacitive region after disconnection of the electrical load from the voltage source.

16. The method of claim 15 further comprising:
reconnecting the electrical load with the converter via the electrical subsystem.

17. A system, comprising:
a power source providing a voltage of at least 400 V;
a converter coupled between the power source and an electrical load selectively electrically connected with the converter; and
an electrical subsystem electrically connected to the power source, the converter, and the electrical load;
wherein, in accordance with detecting a fault associated with operation of the system in a capacitive region after disconnecting the electrical load, the electrical subsystem interrupts operation of the converter before reconnecting the electrical load.

18. The system of claim 17, wherein the electrical subsystem is configured to filter a voltage signal from the converter and apply a gain before detecting the fault.

19. The system of claim 18, wherein the electrical subsystem applies a reference voltage to the voltage signal before detecting the fault.

20. The system of claim 17, wherein the fault indicates at least one of an increase in voltage greater than a first threshold value, a decrease in voltage greater than a second threshold value, and an undervoltage or overvoltage condition.
